(19) United States
(12) Patent Application Publication
(10) Pub. No.: US 2009/0229091 A1
(43) Pub. Date: Sep. 17, 2009

(54) Slide Fastener and a Slider for a Slide Fastener

(75) Inventor: Roberto Peano, Malnate(VA) (IT)

Correspondence Address: AKERMAN SENTERFITT, P.O. BOX 3188, WEST PALM BEACH, FL, 33402-3188, US

(73) Assignee: Riri, S.A., Mendrisio (CH)

(21) Appl. No.: 12/402,112

(22) Filed: Mar. 11, 2009

(30) Foreign Application Priority Data
Mar. 13, 2008 (EP) 08004704.6

(51) Int. Cl. A44B 19/26; B29D 5/00

(52) U.S. Cl. 24/430; 29/409

(57) ABSTRACT

A slide fastener (1) comprising a pair of tapes (2), carrying respective teeth (3), a top stop (4) and a die-cast or injection-molded slider (5), said slider (5) having a structure with an upper blade (8), a lower blade (9), lateral flanges (10, 11) and a diamond (20) connecting the upper and lower blades, wherein a cavity (21) is formed in said diamond (20).

### FIELD OF APPLICATION

The present invention refers to a slide fastener and to a slider of a slide fastener. The invention relates in particular to fluid-tight slide fasteners and sliders thereof.

### PRIOR ART

A slide fastener, in essential terms, comprises a pair of tapes bearing respective rows of teeth, top and bottom stops, and a slider for opening and closing the fastener by engaging and disengaging the teeth.

Fluid-tight slide fasteners are slide fasteners adapted to securely prevent the passage of a liquid and/or gas, e.g. water and/or air. In some cases, a fluid-tight fastener must ensure fluid-tightness even under a significant pressure difference between the interior and the exterior, for example up to about 2 bars. Fluid-tight slide fasteners are realized for example with layered tapes made of a textile core with a waterproof coating layer and injection-molded teeth.

The slider, according to known art, comprises upper and lower blades, lateral flanges and a central portion, called diamond, connecting the upper and lower blades.

A problem of fluid-tight fastener is that the top stop must necessarily have a seat or opening to receive the slider, when the slider reaches the top stop itself, being at the end of its stroke (i.e. full-closed slider); said seat or opening however may be a weak point from the point of view of fluid-tightness and hence it must be adequately sealed when the slider is closed.

According to known art, this is accomplished by a substantially U-shaped top stop with leg portions defining a front opening for the passage of diamond when the slider reaches the top stop, and a seat for receiving said diamond when the slide fastener is fully closed and the slider is accommodated into the top stop.

Lateral flanges of the slider are shaped so that they act on said leg portions of the top stop, in order to close said front opening in a fluid-tight manner when the slider reaches the full-closed position. For example the flanges of the slider, in a plan view, are substantially arranged as a “V”, with an inclined portion adapted to bring together the open ends of the leg portions of the top stop.

Hence, the slider of a fluid-tight slide fastener is designed not only to engage and disengage teeth, but also to close in a fluid-tight manner the opening at the top stop of the slide fastener. It can be understood that, in order to guarantee the fluid-tightness of the closed slide fastener, during the use, the coupling between the slider and the top stop has to meet strict dimensional and geometric tolerances.

This means that the slider must be realized with accuracy and attention to meet the design shape and dimensional tolerances. Otherwise, the slider may be unable to guarantee the sealing at the region of the top stop, in case of excessive clearance between the slider and the top stop itself or, on the other hand, undesired interference between the slider and the top stop, namely between respective flanges and leg portions, may result in a difficult opening/closing of the fastener.

Similar drawbacks may be caused by a deviation from the design shape of the slider, e.g. concerning the curved profile of the flanges, the form of the diamond, and so on.

In die-cast and injection-molded sliders, the applicant has found that the above drawbacks may be caused by the shrinking of the slider during the cooling phase, especially due to fact that the diamond is a relatively thick part of the slider itself, namely thicker than other parts like blades and flanges. It should also be noted that the diamond is the innermost part of the molding, hence the most difficult to cool down.

The cooling of the diamond then is slower than that of said other parts, resulting in different density and temperature distribution in the body of the cooling molded slider and, then, in internal tensions which can deform the slider and produce a deviation from the design shape and/or dimension.

### SUMMARY OF THE INVENTION

The technical problem underlying the invention is to reach a more precise coupling between the slider and the top stop of a slide fastener, particularly with the aim to improve the fluid-tightness at the interface between the slider and the top stop.

This problem is solved by a slide fastener comprising a pair of tapes, carrying respective teeth, a top stop and a slider, said slider having a structure with an upper blade, a lower blade, lateral flanges and a diamond connecting the upper and lower blades, characterized in that the diamond of the slider comprises at least one cavity.

In a preferred embodiment, said at least one cavity is open to one of said upper and lower blades. In a more preferred embodiment, the diamond comprises a blind cavity with an opening in the lower blade of the slider and, more preferably, said cavity extends through the whole diamond from the opening on said lower blade, the cavity having a bottom substantially at the plane of the upper blade.

In a more preferred embodiment, said cavity is symmetrical with respect to a median plane of the diamond, perpendicular to blades of the slider. To obtain a substantially constant thickness of the walls of the slider, defining said cavity, it is preferred that the side surfaces of the cavity are parallel to corresponding external faces of the diamond, so that the cavity has substantially the same shape as the diamond itself. However, a simplified embodiment is possible, wherein said cavity is realized as a cylindrical hole.

In further embodiments, the diamond can be realized with one or more cavities in the form of a passing-through hole or in the form of at least one lateral slit.

The slider may be realized by casting, i.e. die-casting or investment (lost wax) casting, or by injection molding. Preferably, the slider is injection-molded. According to the invention, hence, there is provided a method of forming a slider for a slide fastener by injection-molding or casting of the slider, characterized in that at least one cavity is formed in the diamond of the slider, said cavity being preferably open in at least one of the upper and lower blades of the slider.

An advantage of the invention is that the thickness of the diamond is reduced and made comparable with thickness of the other parts, namely blades and flanges. The cavity having sides parallel to faces of the diamond and then a cross-section corresponding to cross section of the diamond itself, in particular, allows to keep the thickness of the walls of the slider substantially constant.

Hence, the above drawbacks due to non-uniformity of the temperature profile and density of the slider, during the cooling step, are significantly reduced. It follows that the finished product is closer to the nominal dimensions and shape. In other words, the quality is improved and, in a production line, the number of sliders to be rejected is diminished. Another advantage is that the cooling time of the slider is reduced and a higher production rate can be reached.

These and further advantages of the invention will be more evident from the detailed description provided here below, given as indicative and not limiting example.

### BRIEF DESCRIPTION OF THE DRAWINGS

FIG. 1 is a perspective view of the top of a slide fastener according to an embodiment of the invention.

FIG. 2 is a side view of the slider of the slide fastener of FIG. 1.

FIG. 3 is a section according to line III-III of FIG. 2.

FIG. 4 is a sectional view of the slider of FIG. 2.

FIG. 5 is a sketch of the sectioned diamond of the slider of the fastener of FIG. 1.

### DETAILED DESCRIPTION OF PREFERRED EMBODIMENTS

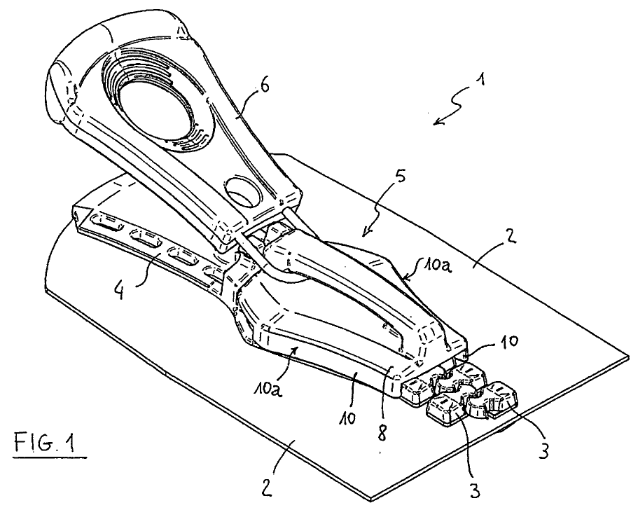

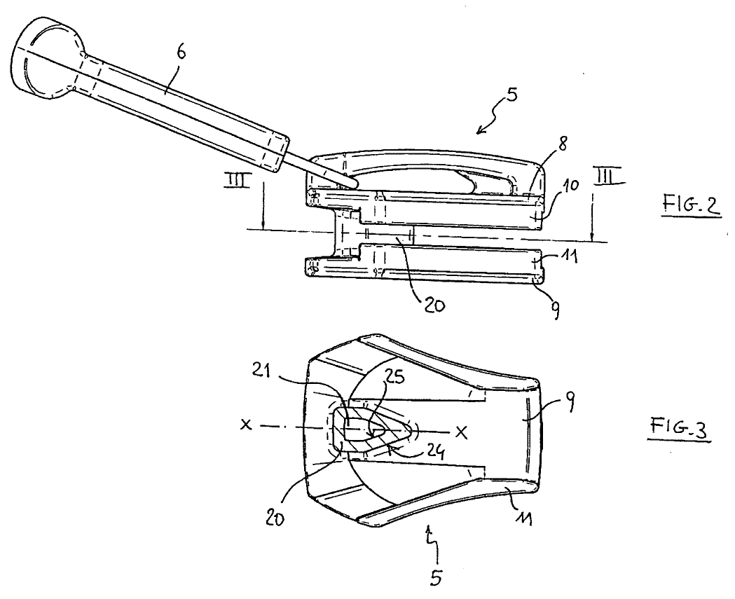

FIG. 1 shows a slide fastener 1, namely the top part thereof, in accordance with a an embodiment of the invention and comprising a pair of tapes 2, equipped with teeth 3, a top stop 4, and a slider 5 with a pull-tab or puller 6.

The slider 5 is movable in a sliding direction, parallel to tapes 2, up to a closing position where the slider 5 is accommodated into the top stop 4, and the fastener 1 is fully closed, i.e. all teeth 3 are engaged. Said closing position is shown in FIG. 1.

Details of tapes 2 an teeth 3 can be according to known art and are not discussed in detail. For example, in a fluid-tight sliding fastener 1, tapes 2 are made of a textile core layer fully coated on both sides by a suitable waterproof layer and teeth 3 are injection molded on tapes 2. The top stop 4 can also be injection-molded on tapes 2.

The slider 5 substantially comprises upper and lower blades 8, 9 with lateral flanges 10, 11 on both sides, and a diamond 20 connecting said upper and lower blades 8, 9. Flanges 10 and 11, in use, act on suitable contact faces of teeth 3 in order to bring the facing teeth of the tapes 2 to reciprocal engagement.

The flanges 10, 11 have a curved profile with diverging parts 10a which, in a plan view, are arranged as the sides of a “V” open towards the top stop 4, as can be seen in FIG. 1. This profile of the flanges 10, 11 is provided to cooperate with appropriate leg portions of the top stop 4 which define a front opening (not shown) and an accommodating seat to receive the diamond 20. In particular, the diverging parts 10a of flanges 10 bring together the ends of said leg portions of the top stop 4, to close and seal said opening around the diamond 20. These details are according to known art and hence they are not described in greater detail.

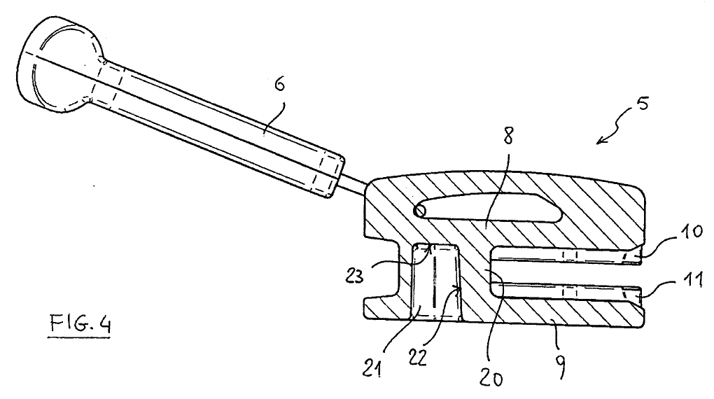

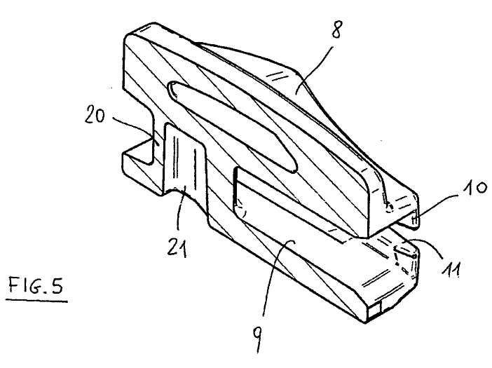

The diamond 20 of the slider 5 comprises a cavity 21, which is open to at least one of said upper and lower blades 8, 9. In the shown example, the cavity 21 is a blind cavity which is symmetrical with respect to a median plane of the diamond 20, perpendicular to blades 8 and 9, as defined by trace X-X of FIG. 3. Said cavity 21 opens in the lower blade 9 of slider 5 and extends through the diamond 20, having a bottom 23 substantially at the plane of the upper blade 8 (FIG. 4). Preferably, the inner surface 22 of cavity 21 is tapered with a draft angle of a few degrees, e.g. 2 to 5 deg, to allow extraction from mold during the manufacturing process.

Each of side surfaces of the cavity, in a more preferred embodiment, is parallel to a corresponding external face of the diamond, so that the cavity has substantially the same shape as the diamond itself. Referring to FIG. 4, a side surface 25 of the cavity 21 is shown, parallel to a corresponding external face 24 of diamond 20. Others faces as parallel to respective faces of the diamond, as apparent from the same FIG. 4.

In other words, the cavity 21 has a perimeter and, then, a cross-section corresponding to cross section of the diamond As a consequence, the walls of the diamond 20, surrounding the cavity 21, have a constant or substantially constant thickness.

As also seen in the sectioned view of FIG. 5, the invention eliminates the presence of a thicker part due to the body of the diamond 20, and the related drawbacks which have been listed above.

In other embodiments, the cavity 21 may be a passing-through hole in the diamond 20 or may be open in the upper blade or in the front of the diamond, the shown embodiment being however preferred. In still another embodiment, the diamond is “cut” by a plurality of lateral slits, removing material from the slider and then reducing the thickness thereof, thus achieving the above mentioned advantages.

Of course, a person skilled in the art can bring other modifications and variants to the slide fastener described above in order to satisfy specific and contingent requirements, all of which are in any case covered by the scope of protection of the present invention, as defined by the following claims.

1. A slide fastener comprising a pair of tapes, carrying respective teeth, a top stop and a slider, said slider having a structure with an upper blade, a lower blade, lateral flanges and a diamond connecting the upper and lower blades, wherein said diamond comprises at least one cavity.

2. A slide fastener according to claim 1, wherein said at least one cavity is open to one of said upper and lower blades of the slider.

3. A slide fastener according to claim 2, wherein said at least one cavity is a blind cavity with an opening in the lower blade of the slider.

4. A slide fastener according to claim 2, wherein said cavity is symmetrical with respect to a median plane of the diamond perpendicular to blades of the slider.

5. A slide fastener according to claim 4, wherein said cavity extends through the diamond having a bottom substantially at the plane of the upper blade.

6. A slide fastener according to claim 1, wherein the cavity has side surfaces substantially parallel to corresponding external faces of the diamond, so that the walls of diamond, surrounding the cavity, have a constant or substantially constant thickness.

7. A slide fastener according to claim 1, wherein said cavity is a passing-through cavity.

8. A slide fastener according to claim 1, wherein the diamond comprises at least one lateral slit forming said at least one cavity.

9. A slide fastener according to claim 1, the slide fastener being fluid-tight.

10. A slider for a slide fastener, the slider having a structure with an upper blade, a lower blade, lateral flanges and a diamond connecting the upper and lower blades, wherein the diamond comprises at least one cavity.

11. A method of forming a slider for a slide fastener by injection molding or casting of said slider, the slider having a structure with an upper blade, a lower blade, lateral flanges and a diamond, the method being characterized in that at least one cavity according to claim 1 is formed in the diamond of the slider.
